(19) United States
(12) Patent Application Publication
(10) Pub. No.: US 2025/0041817 A1
(43) Pub. Date: Feb. 6, 2025

(54) SYSTEMS AND TECHNIQUES FOR GENERATING A GAS BY HYDROCARBON PYROLYSIS

(71) Applicant: Honeywell International Inc., Charlotte, NC (US)

(72) Inventors: Stephen Yates, South Barrington, IL (US); Amanda Childers, Arlington Heights, IL (US)

(21) Appl. No.: 18/362,740

(22) Filed: Jul. 31, 2023

(51) Int. Cl. B01J 8/26; B01J 6/00; B01J 8/02; B01J 8/18; C25B 1/04; C25B 15/08

(52) U.S. Cl. CPC B01J 8/26; B01J 6/008; B01J 8/0278; B01J 8/1827; C25B 1/04; C25B 15/081

(57) ABSTRACT

A system for generating a gas may include a pyrolysis reactor configured to pyrolyze a hydrocarbon to generate hydrogen and carbon. The pyrolysis reactor is further configured to contact the carbon with an agitated bed comprising metal oxide substrate particles to generate carbon-coated metal oxide particles. A technique for generating a gas may include agitating metal oxide substrate particles to form an agitated bed in a pyrolysis reactor. The technique may further include pyrolyzing, in the pyrolysis reactor, a hydrocarbon to generate hydrogen and carbon. The technique may further include contacting, in the pyrolysis reactor, the carbon with the agitated bed to generate carbon-coated metal oxide particles.

### TECHNICAL FIELD

The present disclosure relates to systems and techniques for generating a gas, for example, by hydrocarbon pyrolysis.

### BACKGROUND

Hydrogen gas may be generated from a hydrocarbon by pyrolysis, which may generate solid carbon as a byproduct. The hydrocarbon may include methane. Pyrolysis may be used to generate hydrogen in open-loop (no recycling of a product in a feed to the system) or closed-loop systems (at least partial recycling of a product in a feed to the system).

### SUMMARY

In general, the present disclosure describes systems and techniques for generating a gas, for example, by hydrocarbon pyrolysis. The hydrocarbon pyrolysis may be combined with further processes to ultimately generate oxygen. For example, hydrocarbon pyrolysis may be used as part of an oxygen chain that converts oxide moieties from an oxide source into oxygen gas, and also as part of a carbon loop that facilitates conversion of the oxide moiety into oxygen gas by shuttling oxygen between different forms. The oxide source may include oxide particles. The oxide particles may include any compound including oxygen. The oxide particles may include metal oxide particles. In some examples, the oxide particles include lunar regolith. Thus, systems and techniques according to the present disclosure may be used in lunar missions to generate oxygen from lunar regolith.

The oxide particles may be introduced in a pyrolysis reactor and agitated to form an agitated bed in the pyrolysis reactor. A hydrocarbon may be introduced in the pyrolysis reactor, where the hydrocarbon is pyrolyzed to generate hydrogen gas and solid carbon. The solid carbon formed by the pyrolysis is contacted with the agitated bed to form carbon-coated oxide particles. The agitated bed facilitates receiving and collecting solid carbon generated by pyrolysis, while reducing or preventing blockage of gas flow, so that pyrolysis may continue to generate hydrogen within the pyrolysis reactor. The carbon-coated oxide particles may be removed from the pyrolysis reactor and further processed to ultimately generate free oxygen gas, and to form carbon compounds that may be recycled back to the pyrolysis reactor as part of a carbon loop.

In some examples, the present disclosure describes a system for generating a gas. The system may include a pyrolysis reactor configured to pyrolyze a hydrocarbon to generate hydrogen and carbon. Thus, the gas may include the hydrogen generated by pyrolysis. The pyrolysis reactor may be further configured to contact the carbon with an agitated bed including substrate particles including metal oxide to generate carbon-coated metal oxide particles.

In some examples, the present disclosure describes a technique for generating a gas. The technique may include agitating substrate particles including a metal oxide to form an agitated bed in a pyrolysis reactor. The technique may further include pyrolyzing, in the pyrolysis reactor, a hydrocarbon to generate hydrogen and carbon. The technique may further include contacting, in the pyrolysis reactor, the carbon with the agitated bed to generate carbon-coated particles.

In some examples, the present disclosure describes a technique for generating a gas. The technique may include fluidizing substrate particles including an oxide moiety to form a fluidized bed in a pyrolysis reactor. The technique may further include pyrolyzing, in the pyrolysis reactor, methane to generate hydrogen and carbon. The technique may further include contacting, in the pyrolysis reactor, the carbon with the fluidized bed to generate carbon-coated particles. The technique may further include thermally treating the carbon-coated particles in a carbothermal reactor to produce carbon monoxide. The technique may further include reacting the carbon monoxide by the carbothermal reactor and the hydrogen produced by the pyrolysis reactor over a catalyst in a Sabatier reactor to produce water and methane. The technique may further include transporting the methane from the Sabatier reactor to the pyrolysis reactor. The technique may further include electrolyzing the water in an electrolysis module to produce oxygen and hydrogen. The technique may further include transporting the hydrogen produced by the electrolysis unit to the Sabatier reactor.

The details of one or more examples are set forth in the accompanying drawings and the description below. Other features, objects, and advantages will be apparent from the description and drawings, and from the claims.

### BRIEF DESCRIPTION OF THE FIGURES

The details of one or more examples are set forth in the accompanying drawings and the description below. Other features, objects, and advantages will be apparent from the description and drawings, and from the claims.

FIG. 1 is schematic diagram showing a system for generating a gas including a pyrolysis reactor including an agitated bed of particles.

FIG. 2 is schematic diagram showing a system for generating a gas including a pyrolysis reactor and a moving bed of particles.

FIG. 3 is schematic diagram showing a system including a pyrolysis reactor and a motor configured to rotate a chamber to agitate a bed of particles.

FIG. 4 is a block diagram showing a system including a pyrolysis reactor and a carbothermal reactor.

FIG. 5 is a flowchart representing a technique for generating a gas by hydrocarbon pyrolysis.

### DETAILED DESCRIPTION

In general, the disclosure describes systems and techniques for generating a gas by hydrocarbon pyrolysis. Hydrocarbon pyrolysis may be used to generate hydrogen from a hydrocarbon. Solid carbon, formed as a byproduct of pyrolysis, may be deposited on an agitated bed of substrate particles including an oxygen moiety. The hydrocarbon pyrolysis may form part of a carbon loop, part of an oxygen chain, and part of a hydrogen chain. The oxygen chain may generate free oxygen gas from the oxygen moiety, while the carbon loop and hydrogen loop may respectively recycle carbon and hydrogen. Thus, the gas generated by the present systems and techniques may include at least one of hydrogen gas or oxygen gas.

For example, the carbon loop may include oxidation of solid carbon with the oxygen moiety to form carbon monoxide or carbon dioxide (in a carbothermal reactor), which in turn may be reduced to methane (in a Sabatier reactor). The methane may be converted to solid carbon (in a pyrolysis reactor), which may be combined with the oxygen moiety (in the pyrolysis reactor by depositing the carbon on oxide particles) to close the carbon loop.

In some examples, the present disclosure describes a system for generating a gas. The system may include a pyrolysis reactor configured to pyrolyze a hydrocarbon to generate hydrogen and carbon. The pyrolysis reactor may be further configured to contact the carbon with an agitated bed including substrate particles including oxide to generate carbon-coated particles. The agitated bed facilitates receiving and collecting solid carbon generated by pyrolysis on the particles to coat the particles substantially uniformly. The agitated bed may also reduce the proportion of free solid carbon deposited as soot or dust, by promoting continuous contact between carbon and the agitated bed, which may facilitate an increase in carbon content and coating thickness of the carbon-coated particles. Further, the agitated bed may reduce or prevent blockage of flow caused by static deposits of carbon in the pyrolysis reactor. The carbon-coated oxide particles may be removed from the pyrolysis reactor and transported for further processing, for example, to the carbothermal reactor to oxidize the carbon with oxygen from the oxide particles.

In tandem, the oxygen chain may include transporting oxide particles as a source of the oxygen moicty to the pyrolysis reactor, where the particles may be coated with solid carbon (generated in the pyrolysis reactor from a hydrocarbon) to form carbon-coated oxide particles. The carbon-coated oxide particles may be thermally treated (in the carbothermal reactor) to form the carbon monoxide or the carbon dioxide, transferring oxygen from the oxide moiety to the carbon monoxide or the carbon dioxide. The carbon monoxide or the carbon dioxide may be reduced with hydrogen (in the Sabatier reactor) to form water, further transferring oxygen from the carbon monoxide or carbon dioxide to the water. The water may be electrolyzed to generate oxygen gas from the water (in an electrolysis module), transferring oxygen from the water into free oxygen gas. Thus, the carbon loop and the oxygen chain may operate to generate free oxygen gas from the oxide particles, while recycling carbon.

Combining the carbon loop and the oxygen chain allows cross-utilizing intermediates and products of the carbon loop and the oxygen chain, which promotes efficiency of the overall process and further generates a hydrogen loop. For example, hydrogen gas generated by the pyrolysis reactor and the electrolysis module may be recycled to the Sabatier reactor, the methane generated by the Sabatier reactor may be recycled to the pyrolysis reactor, and water generated by the Sabatier reactor may be sent to the electrolysis module. Thus, methane and water transport hydrogen away from the Sabatier reactor, while hydrogen gas transports hydrogen back to the Sabatier reactor. Thus, both carbon and hydrogen may be substantially conserved in respective closed loops.

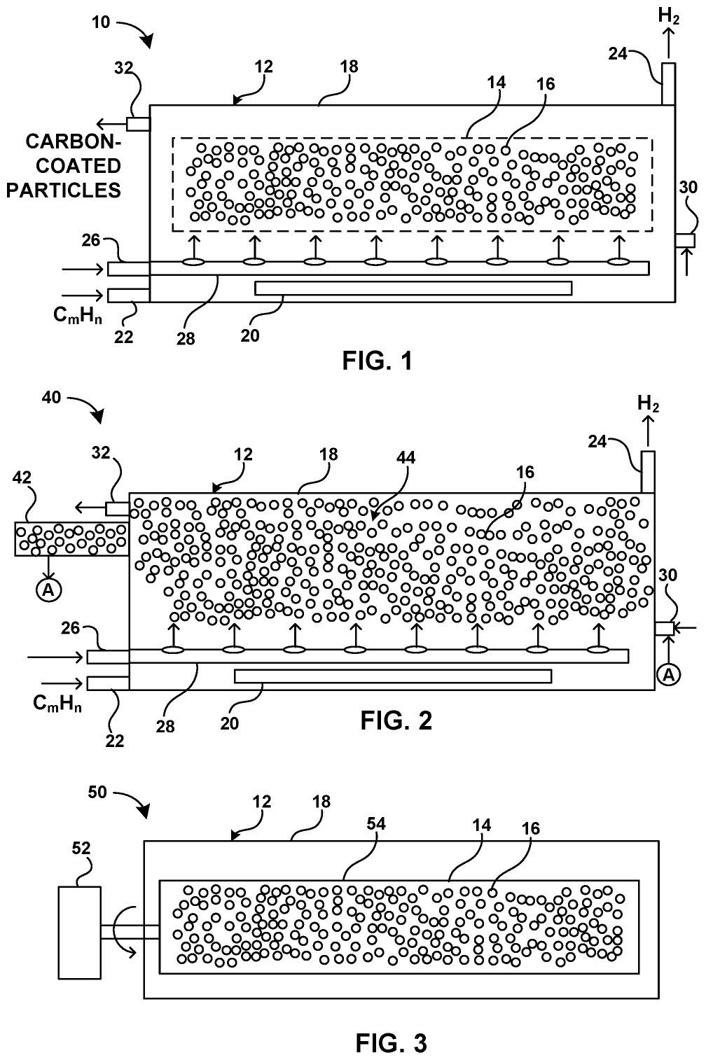

FIG. 1 is schematic diagram showing a system 10 for generating a gas including a pyrolysis reactor 12 including an agitated bed 14 of particles 16.

Pyrolysis reactor 12 is configured to pyrolyze a hydrocarbon to generate hydrogen and carbon. Pyrolysis reactor 12 may include a housing 18 including a heating system 20. Housing 18 may include a metal, an alloy, a ceramic, or any other suitable rigid material. Housing 18 is insulated with a thermal barrier to substantially retain heat generated by heating system 20 within an interior of housing 18. Heating system 20 may include an electrical heating element or any other suitable source of heat, for example, a burner. Heating system 20 may be configured to heat an interior of housing 18 to a pyrolysis temperature range, for example, to at least 900° C., at least 1000° C., at least 1100° C., at least 1200° C., or at least 1250° C. In some examples, the pyrolysis temperature is less than or equal to 1300° C., less than or equal to 1250° C. less than or equal to 1200° C., less than or equal to 1100° C., or less than or equal to 900° C. In some examples, the pyrolysis temperature is in a range from 900° C. to 1300° C. Housing 18 may be configured to maintain a pressure of at least 20 Torr, or at least 50 Torr, or at least 100 Torr.

Pyrolysis reactor 12 may further include a hydrocarbon inlet 22 configured to introduce a hydrocarbon (CₘHₙ) into an interior of housing 18. As shown in FIG. 1, hydrocarbon inlet 22 may be positioned at or adjacent a bottom of housing 18. However, hydrocarbon inlet 22 may be positioned at any other suitable location along housing 18. In some examples, the hydrocarbon introduced by hydrocarbon inlet includes methane. In some examples, the hydrocarbon introduced by hydrocarbon inlet consists of, or consists essentially of, methane. The hydrocarbon may be pyrolyzed in interior of housing 18 to form gaseous hydrogen (H₂) and solid carbon (C). The hydrogen may be released from a hydrogen outlet 24. As shown in FIG. 1. hydrogen outlet 24 may be positioned at or adjacent a top of housing 18. However, hydrogen outlet 24 may be positioned at any suitable location along housing 18.

As pyrolysis progresses, an increasing amount of carbon may be generated. Pyrolysis reactor 12 is configured to contact the carbon with agitated bed 14. Particles 16 of agitated bed 14 include substrate particles, on which carbon is progressively deposited, generating carbon-coated particles. Thus, particles 16 may initially include uncoated substrate particles, and progressively include an increasing fraction of coated substrate particles. Eventually, substantially an entirety of particles 16 may include coated particles with continued carbon deposition. The substrate particles may include an oxide moiety, for example, a metal oxide. The oxide may include a silicate, and the metal oxide may include a metal silicate. In some examples, the substrate particles comprise a calcium salt of an aluminosilicate. In some examples, the substrate particles include lunar regolith. Lunar regolith includes oxygen, for example, in silicates. Lunar regolith may be processed, for example, by at least one of crushing, grinding, or sieving, to form a powder or dust. The substrate particles may include lunar powder or lunar dust. Thus, carbon-coated particles in particles 16 may include an oxide moiety in respective cores of particles 16.

Substrate particles may be introduced by a particle inlet 30. Particle inlet 30 may be located at any suitable location along housing 18, for example, at or adjacent a bottom of housing 18. Particles 16 may be introduced into housing 18 via particle inlet 30 as a predetermined volume or batch, or as a continuous stream. In some examples, housing 18 does not include particle inlet 30, and instead includes a scalable opening (for example, a lid or hatch) to admit a volume or batch of particles 16. The amount of particles 16 (for example, weight or volume) may be selected in view of hydrocarbon content or concentration to be introduced in hydrocarbon inlet 22. For example, the amount of particles 16 may be sufficient to coat a majority of particles 16 with carbon deposited in pyrolysis reactor 12, or coat a substantial majority of particles 16 with carbon. In some examples, the amount of particles 16 is selected such that the carbon coating forms at least a threshold average thickness on a majority of particles 16, or substantially an entirety of particles 16.

In a static bed of particles, deposited carbon may form a continuous film or barrier, or otherwise block passages or voids between particles, tending to resist or reduce flow of gas through the static bed, and thus reducing efficiency of pyrolysis, and reducing the efficiency and uniformity of coating particles in the bed. In contrast, agitated bed 14 allows continued flow, and promotes receiving and collection of carbon coating on particles 16. Further, agitated bed 14 may promote uniform pyrolytic conditions within an interior of housing 18.

Agitated bed 14 may be formed by fluidizing particles 16 with a stream of gas. For example, pyrolysis reactor 12 may include a fluid inlet 26 configured to introduce a stream of gas to fluidize the substrate particles. For example, the stream of gas may include an inert gas or a gas that does not react with the contents of pyrolysis reactor during pyrolysis. In other examples, the stream of gas includes the hydrocarbon introduced into the reactor for pyrolysis. For example, pyrolysis reactor 21 may not include a separate hydrocarbon inlet 22, and instead only include fluid inlet 26 for introducing the hydrocarbon. By using the hydrocarbon itself for fluidization, the complexity of pyrolysis reactor may be reduced, and the number of gas streams in system 10 may be reduced.

Fluid inlet 26 may be fluidically coupled to a sparger 28 within an interior of housing 18. Sparger 28 may include a plurality of openings to distribute the stream of gas (or the hydrocarbon) to uniformly fluidize particles 16 in agitated bed 14. The flow velocity of the stream of gas (or the hydrocarbon) may be selected to provide a suitable fluidization density of agitated bed 14, such that sufficient inter-particle spacing is retained to receive carbon and for gas flow through agitated bed 14. For example, a flow velocity higher than a minimum fluidization velocity may initiate agitation or fluidization, which begins to raise agitated bed 14. Flow velocities equal to or higher than an entrainment velocity tend to destabilize agitated bed 14 and ultimately dissipate agitated bed 14 into an entrained flow of particles. Thus, the flow velocity is maintained lower than the entrainment velocity to retain particles within agitated bed 14. Pyrolysis reactor 12 may thus be configured to fluidize particles 16 to form a fluidized bed, and agitated 14 may include the fluidized bed.

The entrainment velocity is influenced by magnitude of gravitational force. For example, particles in a lunar environment would have a lower weight than particles in a terrestrial environment, and thus, the entrainment velocity would be lower in the lunar environment in comparison with the terrestrial environment. Likewise, the minimum fluidization velocity would be lower in the lunar environment in comparison with the terrestrial environment. The flow velocity may thus be adjusted depending on the environment in which system 10 is operated.

After a predetermined treatment time or residence time, carbon-coated particles may be withdrawn from pyrolysis reactor 12. In some examples, pyrolysis reactor 12 includes a particle outlet 32 for discharging carbon-coated particles. The carbon-coated particles may have a lower density than uncoated particles. Carbon has a lower density than metal oxide, and thus, particles including a carbon coating on a metal oxide core are less dense than the metal oxide core. In examples where the uncoated particles include lunar regolith, the density of lunar regolith may be about 2.8 g/cm³. The density of the accumulated carbon may be about 1.9 g/cm³. Without being bound by theory, if sufficient carbon is accumulated to completely react with the oxygen content of the regolith at a later stage (for example, one mole of accumulated carbon per mole of oxygen in the regolith), then a coated particle may contain 66% regolith and 33% carbon, by volume. Particles having such a composition may have a weighted average density of about 2.5 g/cm³.

Therefore, carbon-coated particles may tend to rise relative to uncoated particles against a direction of gravity. In some examples, particle outlet 32 is located at or adjacent a top of pyrolysis reactor 12. For example, uncoated particles may be introduced at or adjacent a bottom of pyrolysis reactor 12, and rise through agitated bed 14 in course of accumulating a carbon coating toward particle outlet 32.

Particle outlet 32 may be coupled to a fan, an impeller, or a pump to facilitate a flow or stream for discharging carbon-coated particles through particle outlet 32. For example, a volume of carbon-coated particles may be discharged, and a new volume of particles 16 may be introduced into the interior of housing 18. In some examples, pyrolysis reactor 12 may not include particle outlet 32, and particles may be withdrawn from a hatch or opening also used to introduce a volume of particles. For example, a batch of particles 16 may be introduced into pyrolysis reactor, and withdrawn as a batch of carbon-coated particles. In some examples, a continuous or intermittent stream of particles 16 is introduced into pyrolysis reactor 12, and a continuous or intermittent stream of carbon-coated particles is withdrawn from pyrolysis reactor 12.

Instead of, or in addition to, fluidization, pyrolysis reactor 12 may be configured to agitate particles 16 to form agitated bed by mechanical agitation, for example, by stirring particles 16, or by rotating or agitating housing 18 or another portion of reactor 12.

FIG. 2 is schematic diagram showing a system 40 for generating a gas including pyrolysis reactor 12 and a moving bed 44 of particles 16. System 40 may be similar to system 10, and differ in the presence of moving bed 44. Moving bed 44 may be agitated or fluidized similar to agitated bed 14, but recirculated through pyrolysis reactor. For example, partially coated particles may have a density intermediate between completely coated particles and uncoated particles, and may rise within pyrolysis reactor 12 to a height below the completely coated particles, but above uncoated particles. Completely coated particles, for example, particles having a coating of a predetermined thickness or having a density lower than a threshold density, may rise to a top of pyrolysis reactor 12, and may be withdrawn from outlet 32 near or adjacent top of pyrolysis reactor 12. Pyrolysis reactor 12 may include a recirculation outlet 42 below outlet 32, from which partially coated particles may be withdrawn and reintroduced into inlet 30. In some examples, partially coated particles may be mixed with a volume of uncoated particles and reintroduced into inlet 30. As particles are recirculated through pyrolysis reactor 12 for one, two, or more cycles, an increasing extent of carbon may accumulate on the particles, progressively increasing the thickness of the carbon coating on the particles. In some examples, a volume of particles continues to recirculate through pyrolysis reactor 12 until the density is sufficiently reduced to raise that volume of particles to outlet 32. ending their recirculation. Thus, respective heights of outlet 32 and recirculation outlet 42 may be adjusted based on predetermined final or intermediate coating thickness or particle density.

FIG. 3 is schematic diagram showing a system 50 including pyrolysis reactor 12 and a motor 52 configured to rotate pyrolysis reactor 12 to agitate bed 14 of particles 16. For example, motor 52 may rotate an entire housing 18 of pyrolysis reactor 12, or may rotate an agitation chamber 54. In some examples, agitation chamber 54 may include a screened or meshed chamber housing that retains agitated bed 14, and agitates bed 14 by rotation. Motor 52 may be positioned in an exterior of housing 18, and coupled to housing 18 or agitation chamber 54 by a shaft.

Thus, the present disclosure describes pyrolysis systems and reactors configured to form hydrogen by pyrolysis of a hydrocarbon, and to produce carbon-coated particles in an agitated bed using carbon produced as a byproduct of the pyrolysis. Pyrolysis systems and reactors according to the present disclosure may be used as part of further systems or assemblies, for example, a system for producing gaseous oxygen from an oxide source.

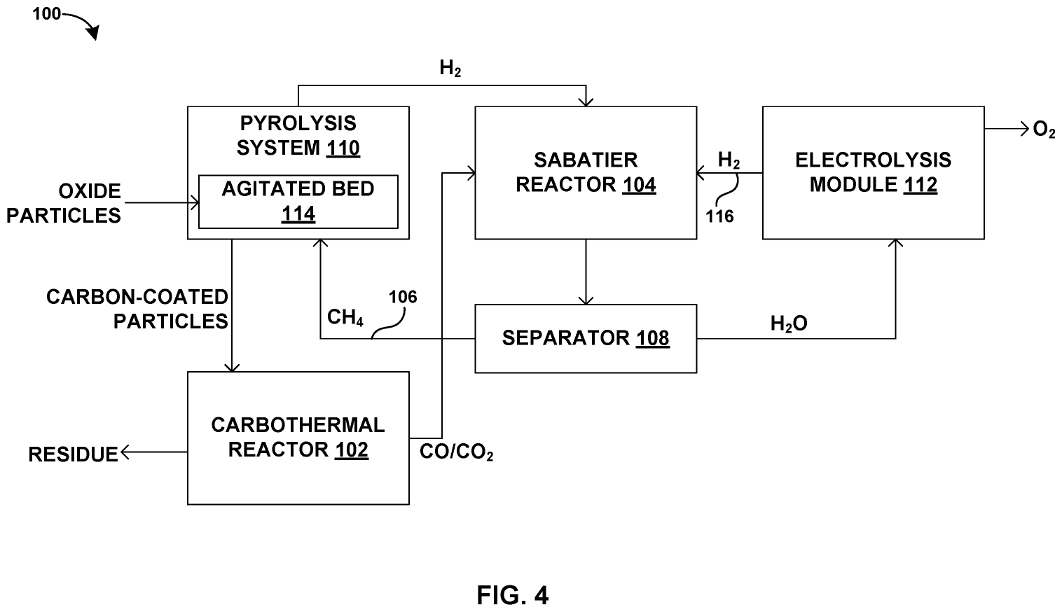

FIG. 4 is a block diagram showing a system 100 including a carbothermal reactor 102 and a pyrolysis system 110. For example, pyrolysis system 110 may include system 10, 40, or 50, or any other pyrolysis system according to the present disclosure, or pyrolysis reactor 12, or any other pyrolysis reactor according to the present disclosure. Pyrolysis system 102, or a pyrolysis reactor of system 102, may include an agitated bed 114. Agitated bed 114 may be similar to agitated bed 14 described with reference to FIG. 1, or any other agitated bed according to the present disclosure.

Carbothermal reactor 102 is fluidically coupled to a pyrolysis reactor, for example, in pyrolysis system 110. Carbothermal reactor 102 is configured to thermally treat carbon-coated particles received from pyrolysis system 110 to produce one or both of carbon monoxide or carbon dioxide. Carbothermal reactor 102 includes a heating element for thermally treating the carbon-coated particles. The heating element may be an electrical heating element, or any other suitable heating element.

The carbon-coated particles include an oxide moiety, and thermal treatment of carbon-coated particles including the oxide moiety in carbothermal reactor 102 oxides free carbon in the coating with oxide from the particles to generate carbon monoxide or carbon dioxide. A remaining content of the carbon-coated particles may generate residue, which may be discharged from carbothermal reactor 102 for discarding or further processing. In examples in which the carbon-coated particles include a metal oxide or lunar regolith, the residue may include a metal, an alloy, or a metallic slag.

In some examples, carbothermal reactor 102 is configured to receive a continuous or intermittent stream of carbon-coated particles from pyrolysis system 110. In other examples, carbothermal reactor 102 is configured to receive a volume or batch of carbon-coated particles from pyrolysis system 110.

System 100 may further include a Sabatier reactor 104 fluidically coupled to pyrolysis system 110 (or a pyrolysis reactor in system 110) and carbothermal reactor 102. Sabatier reactor 104 is configured to react one or both of the carbon monoxide or the carbon dioxide produced by carbothermal reactor 102 and the hydrogen produced by pyrolysis system 110 (or hydrogen from another source) over a catalyst in Sabatier reactor 104 to produce water and methane. The catalyst may include a nickel-based catalyst, a ruthenium-based catalyst, a rhodium-based catalyst, or any other suitable Sabatier process catalyst.

In some examples, system 100 further includes a methane line 106 fluidically coupling Sabatier reactor 104 to pyrolysis system 110 (or a pyrolysis reactor) and configured to transport methane produced by Sabatier reactor 104 to pyrolysis system 110.

System 100 may further include a separator 108, downstream of Sabatier reactor 104. Separator 108 may include one or more of a condenser, a filter, or a membrane, configured to separate water from methane (or any hydrocarbons) produced by Sabatier reactor 104. In some examples, the membrane includes a zeolite membrane. Methane (or any hydrocarbons) produced by Sabatier reactor may be separated by separator 108, and transported to pyrolysis system 110.

System 100 may further include an electrolysis module 112 fluidically coupled to Sabatier reactor 104 and configured to electrolyze the water produced by Sabatier reactor 104 to produce oxygen (O₂, for example, free gaseous oxygen) and hydrogen (H₂, for example, free hydrogen gas). In some examples, electrolysis module 112 is coupled to separator 108 to receive water extracted from Sabatier reactor 104 via separator 108. Electrolysis module 112 may include an electric power supply to receive electrical power to conduct electrolysis. The oxygen generated by electrolysis module 112 may be or one or more of scrubbed or filtered (to remove moisture or contaminants) or stored in an oxygen tank.

System 100 may further include a hydrogen line 116 coupling electrolysis module 112 and Sabatier reactor 104 and configured to transport the hydrogen produced by electrolysis unit 112 to Sabatier reactor 104.

System 100 thus includes an oxygen chain, beginning with oxide particles introduced in pyrolysis system 110, continuing with carbon-coated particles transported to carbothermal reactor 102, further continuing with carbon monoxide or carbon dioxide transported from carbothermal reactor 102 to Sabatier reactor 104, further continuing with water generated by Sabatier reactor 104, and terminating with gaseous oxygen produced by electrolysis module 112 from the water.

System 100 further includes a closed carbon loop, including carbon-coated particles generated by pyrolysis system 110, continuing to carbon monoxide or carbon dioxide produced by carbothermal reactor 102, continuing to methane (or other hydrocarbons) produced by Sabatier reactor 104, and returning as methane (or other hydrocarbons) to pyrolysis system 110, where carbon is again generated as a solid carbon coating.

System 100 further includes a closed hydrogen loop, including hydrogen particles generated by pyrolysis system 110, continuing to water and methane (or other hydrocarbons) produced by Sabatier reactor 104, and returning as methane (or other hydrocarbons) to pyrolysis system 110 from Sabatier reactor 104, and returning as hydrogen from electrolysis module 112 to Sabatier reactor 104.

Thus, system 100 may be used to recycle carbon and hydrogen in substantially closed loops, and generate gaseous oxygen from an oxide source, for example, oxide particles, or lunar regolith.

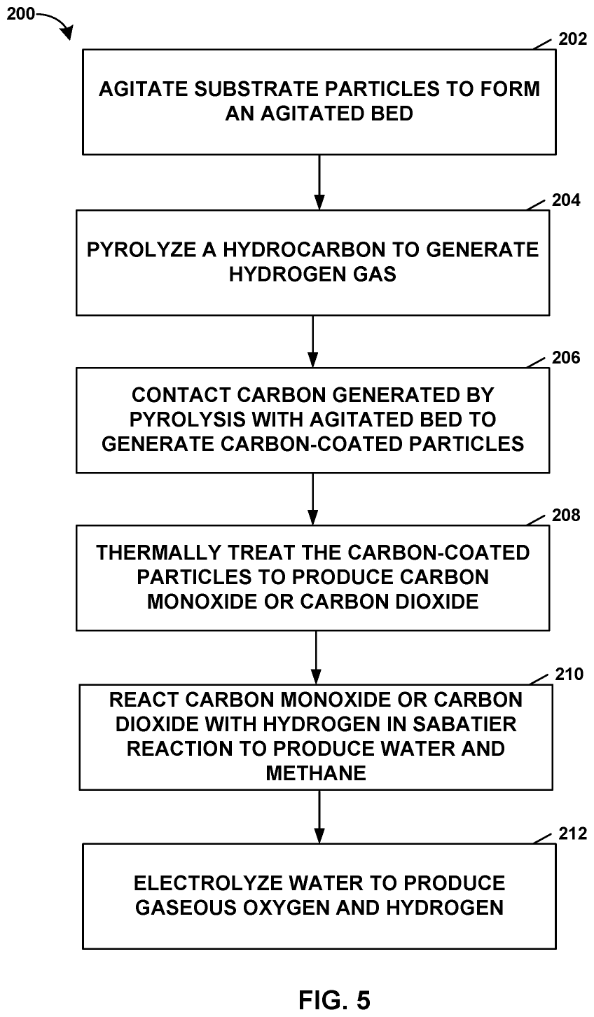

FIG. 5 is a flowchart representing a technique 200 for generating a gas by hydrocarbon pyrolysis. Technique 200 may be implemented by system 100, or by any other suitable system.

Technique 200 may include agitating substrate particles to form an agitated bed in a pyrolysis reactor (202). The agitation (202) may include fluidization or stirring. The substrate particles include an oxide moiety. For example, the substrate particles may include metal oxide particles. In some examples, the substrate particles include a calcium salt of an aluminosilicate. In some examples, the substrate particles include lunar regolith.

Technique 200 may further include pyrolyzing, in the pyrolysis reactor, a hydrocarbon to generate hydrogen and carbon (204). Technique 200 may further include contacting, in the pyrolysis reactor, the carbon with the agitated bed to generate carbon-coated particles (206).

In some examples, the contacting (206) includes recirculating partially coated particles from a recirculation outlet to an inlet of the pyrolysis reactor to form a moving bed of particles. For example, the agitation (202) may be controlled induce recirculation during the contacting (206).

Technique 200 may further include thermally treating the carbon-coated particles in a carbothermal reactor to produce one or both of carbon monoxide or carbon dioxide (208). In some examples, the thermally treating the carbon-coated particles (208) produces carbon monoxide.

Technique 200 may further include reacting one or both of the carbon monoxide or the carbon dioxide by the carbothermal reactor and the hydrogen produced by the pyrolysis reactor over a catalyst in a Sabatier reactor to produce water and methane (210). The hydrocarbon pyrolyzed at step 204 may include at least some methane produced by the Sabatier reactor at step 210. For example, technique 200 may further include transporting the methane from the Sabatier reactor to the pyrolysis reactor.

Technique 200 may further include electrolyzing the water in an electrolysis module to produce oxygen and hydrogen (212). Technique 200 may further include transporting the hydrogen produced by the electrolysis unit to the Sabatier reactor.

Systems and techniques according to the present disclosure may be used to generate gas by hydrocarbon pyrolysis in any suitable environment, for example, a terrestrial environment or a non-terrestrial environment. The non-terrestrial environment may include a lunar environment or a non-terrestrial vehicle, craft, or station.

The following clauses illustrate example subject matter described herein.

Clause 1: A system for generating a gas, the system including: a pyrolysis reactor configured to: pyrolyze a hydrocarbon to generate hydrogen and carbon; and contact the carbon with an agitated bed including substrate particles including a metal oxide to generate carbon-coated particles.

Clause 2: The system of clause 1, where the pyrolysis reactor is configured to fluidize the substrate particles to form a fluidized bed, where the agitated bed includes the fluidized bed.

Clause 3: The system of clause 2, where the pyrolysis reactor includes a fluid inlet configured to introduce a stream of gas to fluidize the substrate particles.

Clause 4: The system of clause 3, where the stream of gas includes the hydrocarbon.

Clause 5: The system of any of clauses 1 to 4, where the pyrolysis reactor further includes a stirrer configured to stir the substrate particles.

Clause 6: The system of any of clauses 1 to 5, where the system further includes a motor configured to rotate the pyrolysis reactor to agitate the substrate particles.

Clause 7: The system of any of clauses 1 to 6, further including a carbothermal reactor fluidically coupled to the pyrolysis reactor, where the carbothermal reactor is configured to thermally treat the carbon-coated particles to produce one or both of carbon monoxide or carbon dioxide.

Clause 8: The system of clause 7, further including a Sabatier reactor fluidically coupled to the pyrolysis reactor and the carbothermal reactor, where the Sabatier reactor is configured to react one or both of the carbon monoxide or the carbon dioxide produced by the carbothermal reactor and the hydrogen produced by the pyrolysis reactor over a catalyst in the Sabatier reactor to produce water and methane.

Clause 9: The system of clause 8, further including a methane line fluidically coupling the Sabatier reactor to the pyrolysis reactor and configured to transport methane produced by the Sabatier reactor to the pyrolysis reactor.

Clause 10: The system of clause 8, further including an electrolysis module fluidically coupled to the Sabatier reactor and configured to electrolyze the water produced by the Sabatier reactor to produce oxygen and hydrogen.

Clause 11: The system of clause 10, further including a hydrogen line coupling the electrolysis module and the Sabatier reactor and configured to transport the hydrogen produced by the electrolysis unit to the Sabatier reactor.

Clause 12: A method for generating a gas, the method including: agitating substrate particles including a metal oxide to form an agitated bed in a pyrolysis reactor; pyrolyzing, in the pyrolysis reactor, a hydrocarbon to generate hydrogen and carbon; and contacting, in the pyrolysis reactor, the carbon with the agitated bed to generate carbon-coated particles.

Clause 13: The method of clause 12, where the agitation includes fluidization or stirring.

Clause 14: The method of any of clauses 12 or 13, where the substrate particles include a calcium salt of an aluminosilicate.

Clause 15: The method of clause 14, where the substrate particles include lunar regolith.

Clause 16: The method of any of clauses 12 to 15, further including thermally treating the carbon-coated particles in a carbothermal reactor to produce one or both of carbon monoxide or carbon dioxide.

Clause 17: The method of clause 16, further including reacting the one or both of carbon monoxide or carbon dioxide produced by the carbothermal reactor and the hydrogen produced by the pyrolysis reactor over a catalyst in a Sabatier reactor to produce water and methane.

Clause 18: The method of clause 17, where the hydrocarbon includes at least some methane transported from the Sabatier reactor to the pyrolysis reactor.

Clause 19: The method of any of clauses 17 or 18, further including electrolyzing the water in an electrolysis module to produce oxygen and hydrogen, and transporting the hydrogen produced by the electrolysis unit to the Sabatier reactor.

Clause 20: A method for generating a gas, the method including: fluidizing substrate particles including an oxide moiety to form a fluidized bed in a pyrolysis reactor; pyrolyzing, in the pyrolysis reactor, methane to generate hydrogen and carbon; contacting, in the pyrolysis reactor, the carbon with the fluidized bed to generate carbon-coated particles; thermally treating the carbon-coated particles in a carbothermal reactor to produce carbon monoxide; reacting the carbon monoxide by the carbothermal reactor and the hydrogen produced by the pyrolysis reactor over a catalyst in a Sabatier reactor to produce water and methane; transporting the methane from the Sabatier reactor to the pyrolysis reactor; electrolyzing the water in an electrolysis module to produce oxygen and hydrogen; and transporting the hydrogen produced by the electrolysis unit to the Sabatier reactor.

Various examples have been described. These and other examples are within the scope of the following claims.

What is claimed is:

1. A system for generating a gas, the system comprising:
a pyrolysis reactor configured to:
pyrolyze a hydrocarbon to generate hydrogen and carbon; and
contact the carbon with an agitated bed comprising substrate particles comprising a metal oxide to generate carbon-coated particles.

2. The system of claim 1, wherein the pyrolysis reactor is configured to fluidize the substrate particles to form a fluidized bed, wherein the agitated bed comprises the fluidized bed.

3. The system of claim 2, wherein the pyrolysis reactor comprises a fluid inlet configured to introduce a stream of fluidizing gas.

4. The system of claim 3, wherein the stream of fluidizing gas comprises the hydrocarbon.

5. The system of claim 1, wherein the pyrolysis reactor further comprises a stirrer configured to stir the substrate particles.

6. The system of claim 1, wherein the system further comprises a motor configured to rotate the pyrolysis reactor.

7. The system of claim 1, further comprising a carbothermal reactor fluidically coupled to the pyrolysis reactor, wherein the carbothermal reactor is configured to thermally treat the carbon-coated particles to produce one or both of carbon monoxide or carbon dioxide.

8. The system of claim 7, further comprising a Sabatier reactor fluidically coupled to the pyrolysis reactor and the carbothermal reactor, wherein the Sabatier reactor is configured to react one or both of the carbon monoxide or the carbon dioxide produced by the carbothermal reactor and the hydrogen produced by the pyrolysis reactor over a catalyst in the Sabatier reactor to produce water and methane.

9. The system of claim 8, further comprising a methane line fluidically coupling the Sabatier reactor to the pyrolysis reactor and configured to transport methane produced by the Sabatier reactor to the pyrolysis reactor.

10. The system of claim 8, further comprising an electrolysis module fluidically coupled to the Sabatier reactor and configured to electrolyze the water produced by the Sabatier reactor to produce oxygen and hydrogen.

11. The system of claim 10, further comprising a hydrogen line coupling the electrolysis module and the Sabatier reactor and configured to transport the hydrogen produced by the electrolysis unit to the Sabatier reactor.

12. A method for generating a gas, the method comprising:
agitating substrate particles comprising a metal oxide to form an agitated bed in a pyrolysis reactor;
pyrolyzing, in the pyrolysis reactor, a hydrocarbon to generate hydrogen and carbon; and
contacting, in the pyrolysis reactor, the carbon with the agitated bed to generate carbon-coated particles.

13. The method of claim 12, wherein the agitation comprises fluidization or stirring.

14. The method of claim 12, wherein the substrate particles comprise a calcium salt of an aluminosilicate.

15. The method of claim 14, wherein the substrate particles comprise lunar regolith.

16. The method of claim 12, further comprising thermally treating the carbon-coated particles in a carbothermal reactor to produce one or both of carbon monoxide or carbon dioxide.

17. The method of claim 16, further comprising reacting the one or both of carbon monoxide or carbon dioxide produced by the carbothermal reactor and the hydrogen produced by the pyrolysis reactor over a catalyst in a Sabatier reactor to produce water and methane.

18. The method of claim 17, wherein the hydrocarbon comprises at least some methane transported from the Sabatier reactor to the pyrolysis reactor.

19. The method of claim 17, further comprising electrolyzing the water in an electrolysis module to produce oxygen and hydrogen, and transporting the hydrogen produced by the electrolysis unit to the Sabatier reactor.

20. A method for generating a gas, the method comprising:
fluidizing substrate particles comprising an oxide moiety to form a fluidized bed in a pyrolysis reactor;
pyrolyzing, in the pyrolysis reactor, methane to generate hydrogen and carbon;
contacting, in the pyrolysis reactor, the carbon with the fluidized bed to generate carbon-coated particles;
thermally treating the carbon-coated particles in a carbothermal reactor to produce carbon monoxide;
reacting the carbon monoxide by the carbothermal reactor and the hydrogen produced by the pyrolysis reactor over a catalyst in a Sabatier reactor to produce water and methane;
transporting the methane from the Sabatier reactor to the pyrolysis reactor;
electrolyzing the water in an electrolysis module to produce oxygen and hydrogen; and
transporting the hydrogen produced by the electrolysis unit to the Sabatier reactor.
